(19) United States
(12) Patent Application Publication
(10) Pub. No.: US 2005/0040614 A1
(43) Pub. Date: Feb. 24, 2005

(54) Nestable and attachable cart and method of use

(76) Inventors: Christopher M. Johnson, Richmond, VA (US); Ralph McCann III, Richmond, VA (US)

Correspondence Address: MCGUIREWOODS, LLP, 1750 TYSONS BLVD, SUITE 1800, MCLEAN, VA, 22102, US

(21) Appl. No.: 10/865,992

(22) Filed: Jun. 14, 2004

Related U.S. Application Data
(60) Provisional application No. 60/496,686, filed on Aug. 21, 2003.

(51) Int. Cl. B62D 39/00

(52) U.S. Cl. 280/33.991

(57) ABSTRACT

A cart having a frame member with upright and lateral frame portions. A platform is attached to the lateral frame portion and a removable seat assembly is secured to the upright frame portion. The cart includes a coupling mechanism for coupling to an adjacent cart, of a different type, if required. The platform may be pivotally attached to the frame member. The cart may be nestable.

### CROSS REFERENCE TO RELATED APPLICATIONS

This application claims priority to U.S. provisional application Ser. No. 60/496,686, filed on Aug. 21, 2003, which is incorporated by reference in its entirety herein.

### BACKGROUND OF THE INVENTION

1. Field of the Invention

The invention generally relates to a cart and, more particularly, to a nestable cart having a coupling mechanism and a removable seat.

2. Background Description

There are many types of carts that are currently in use within the retail industry. These carts include, for example, conventional shopping carts, general purpose merchandise carts, e.g., flatbed carts, wagons having plastic trays to a host of other types of specialty carts. Such carts are designed for use in carrying a wide variety of items found in the many different retail environments. For example, flatbed carts are well adapted to greenhouses, light hardware, home improvement, office supply, and wholesale distributors. Similarly, wagons are also well adapted to many of these same retail environments. Conventional shopping carts, on the other hand, are well suited to supermarkets and department stores, in addition to the above retail environments.

Many of these carts are specifically designed for durability as well as versatility. For example, many carts are made from plastics which are capable of withstanding extreme conditions such as inclement weather and shopper abuse, to name a few. Carts are also designed, in many instances, to be nested with like type carts. This nesting feature conserves retail flooring space, leaving valuable retail flooring space available for sale items. In addition, these nesting features allow for easy transport of several carts during a single trip. In addition to these features, shopping carts may also provide versatile features such as integrated child seats, flexible type bags that can be retracted and opened, lower trays, in addition to convertible strollers.

However, these many different types of carts are not easily compatible with one another. That is, these carts cannot be attached and detached to one another without complex coupling mechanisms. For instance, it is not easily possible with currently manufactured carts to use a shopping cart with a flat bed cart, for example, to expand the cargo and carrying capacity of either type of cart. If such a combination was made, though, it would require brackets, nuts, bolts and several tools to connect the two different types of carts. This would require “down” time for the carts and would not be very practical. Also, such connections could not easily be detached to separate the carts.

The invention is directed to overcoming one or more of the problems as set forth above.

### SUMMARY OF THE INVENTION

In a first aspect of the invention, a cart includes a frame member and a module unit pivotally mounted to the frame member. A coupling mechanism is associated with the module unit which is adapted to be removably engagable with a frame member or basket of another cart.

In another aspect of the invention, a nestable cart includes a frame member and a platform pivotally mounted to the frame member between a flat position and a raised position. The platform has a front portion lower than a rear portion with respect to a supporting surface. A coupling mechanism is associated with the platform which includes at least a groove extending widthwise within a front portion of the platform.

In yet another aspect of the invention, an array of nestable carts includes a first cart including a frame member and a module unit pivotally mounted to the frame member between a flat position and a raised position. The module unit has a front portion lower than a rear portion with respect to a supporting surface and a coupling mechanism associated with the module unit including at least a groove extending within the module unit. The second cart, amongst other features, includes a module unit mounted to the frame member and having a front portion lower than a rear portion. A portion of the frame member and module unit of the second cart is positionable underneath the module unit and between frame components of the frame member of the first cart. A rear portion of the module unit of the first cart is positionable in the raised position.

In still another aspect of the invention, an assembly includes a first cart having a frame member and a platform pivotally mounted to the frame member between a flat position and a raised position. The platform has a front portion lower than a rear portion with respect to a supporting surface. A coupling mechanism is combinable with the platform. A second cart includes a frame member having a bar or basket at a height lower than or at a height of a lower portion of the coupling mechanism and wheels rotatably mounted to the frame member. The coupling mechanism engages the bar or the basket of the frame member of the second cart when the platform and a portion of the frame member of the first cart nest within frame components of the frame member of the second cart.

The invention further includes a removable seat including a seat portion and a rear portion proximate to the seat portion having an engaging surface and a recess portion positioned between a locking mechanism. The locking mechanism includes a lock movable between a first position and a second position.

In another aspect of the invention, the cart includes a frame member and a module unit attached to the frame member. A coupling mechanism communicates with the module unit which is removably engagable with a frame member or basket of another cart.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows a perspective view of a cart frame in accordance with the invention;

FIG. 2 shows a tray or platform used with the cart frame of FIG. 1 in accordance with the invention;

FIG. 3 shows a side view of the cart in accordance with the invention;

FIG. 4 shows a side view of the cart in accordance with the invention;

FIG. 5 shows an exploded rear view of the cart in accordance with the invention;

FIG. 6 shows a cutaway side view of the cart along line 6-6 of FIG. 5;

FIG. 7 shows the nesting of several carts in accordance with the invention;

FIG. 8 shows a representative view of an underside of the cart and platform in accordance with the invention;

FIG. 9 shows an embodiment of the platform in accordance with the invention;

FIG. 10 shows a first type cart coupled to a second type cart in accordance with the invention;

FIG. 11 shows a side view of the coupled assembly of FIG. 10;

FIG. 12 shows an exploded view of the coupling mechanism in accordance with one aspect of the invention, along line 12-12 of FIG. 11;

FIG. 13 shows an exploded view of a front portion of the cart and a rear portion of a conventional shopping cart;

FIGS. 14-16 show supplemental or alternative coupling mechanisms in accordance with the invention;

FIG. 17 shows an embodiment of the invention with a removable seat;

FIG. 18 shows a rear view of the embodiment of FIG. 17; and

FIG. 19 shows an exploded view of the removable seat in accordance with the invention.

### DETAILED DESCRIPTION OF EMBODIMENTS OF THE INVENTION

The invention is directed to a cart and/or accompanying coupling mechanism which allows carts to be coupled and detached from one another without the need for special tools or permanent mounting brackets using nuts, bolts and the like. In one aspect, the cart (and accompanying features) or the coupling mechanism for attaching carts may be provided, alone. The versatility and flexibility of the cart allows the coupling and detachment of the carts by the consumer in the retail environment thus allowing for immediate expansion and contraction of the cargo capacity of the cart. The coupling mechanism may be used to attach or couple two different types of carts to one another such as, for example, a general purpose merchandise cart (e.g., a flatbed cart) to a shopping cart.

In one method of attachment, the carts are aligned, by use of a self aligning feature, and then mated or nested together (e.g., moved toward one another) until the coupling mechanism engages to couple the two carts. The coupling mechanism also permits ease of detachment of the carts by a simple motion such as, for example, the lifting of a platform (e.g., carrying tray) of one of the carts. The decoupling or detachment of the carts may also be accomplished by lifting one of the carts, itself. In one aspect of the invention, the cart may be nestable and is able to accommodate a novel removable seat. The latter feature allows for additional versatility by allowing a person to sit within the cart of the invention regardless of whether the cart is coupled or separated from another cart.

### Embodiments of the Cart of the Invention

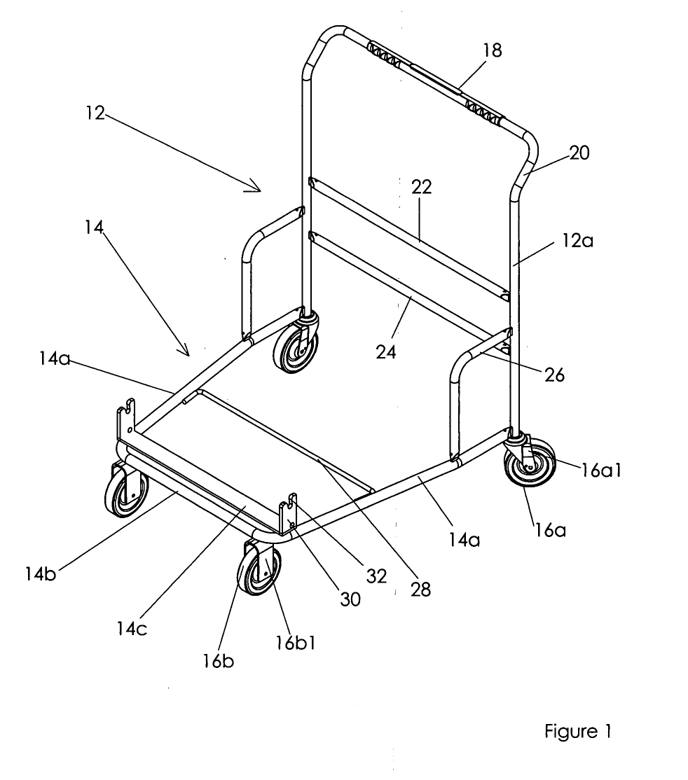

Referring now to FIG. 1, a cart frame of the invention is shown. The cart is generally depicted as reference numeral 10 and includes frame members 12, 14 supported by a set of rear wheels 16a and a set of front wheels 16b mounted to the respective frame members 12, 14, via wheel mounts 16a₁ and 16b₁, respectively. The rear wheels 16a may equally be mounted to the frame member 14 or an intermediate plate at ends thereof. In one aspect of the invention, the rear wheels 16a pivot about a vertical axis, as represented by upright frame members 12a of the frame member 12 thus permitting easy guiding of the cart 10, e.g., allowing the cart to easily pivot. The front wheels 16b preferably do not pivot about a vertical axis. The front wheels 16a may also be mounted to an intermediate plate which is attached to the frame member 14 or 12. However, it should be understood by those of ordinary skill in the art that the front wheels 16b may pivot and the rear wheels 16a may be rigidly mounted to the ends of the upright frame members 12a of the frame member 12 or an intermediate plate, or any combination thereof.

In embodiments, the frame member 12 is a substantially U-shaped frame member including the upright frame members 12a. A handle 18 may span between the upright frame members 12a which, in one embodiment, may include any type of conventional grip. The handle may also be offset from the upright frame members 12a via a rearward bent portion 20 in the upright frame members 12a. Although this feature is not critical to the understanding of the invention, the bent portion does provide certain advantages such as, for example, allowing the handle to be ergonomically positioned for the consumer. Two cross bars 22 and 24 extend between the upright frame members 12a, and may be used for additional support against torsion and rotational forces, e.g., provides stiffness to the cart 10, as well as to retain objects on the cart. In one aspect of the invention as discussed in more detail below, at least one cross member may be used as a support for a removable seat.

Still referring to FIG. 1, the frame member 14, also substantially U-shaped, extends substantially orthogonally from the frame member 12. Support members 26 are provided between the upright frame members 12a and the horizontal frame members 14a of the frame member 14. These support members 26 may be angled, as shown in FIG. 1, and are preferably configured with a substantially 90 degree bend. The support members 26 also provide stiffness to the cart 10 and may also be used to support a removable seat, as discussed below. A cross bar 28 is attached or fixed between the horizontal frame members 14a of the frame member 14. The frame members and other components discussed herein may be welded or bolted together, or may equally be molded from a plastic depending on the specific application.

At least one plate 30 is attached or fixed to the frame member 14 at the opposing horizontal frame members 14a. The plates 30 include a forward extending angle slot 32, which may be partly or wholly used as the coupling mechanism. In one aspect of the invention, a single plate 30 is also contemplated for use by the invention. This single plate 30 may be located, for example, on either of the horizontal frame members 14a or the front, transverse frame member 14b or an intermediate plate 14c.

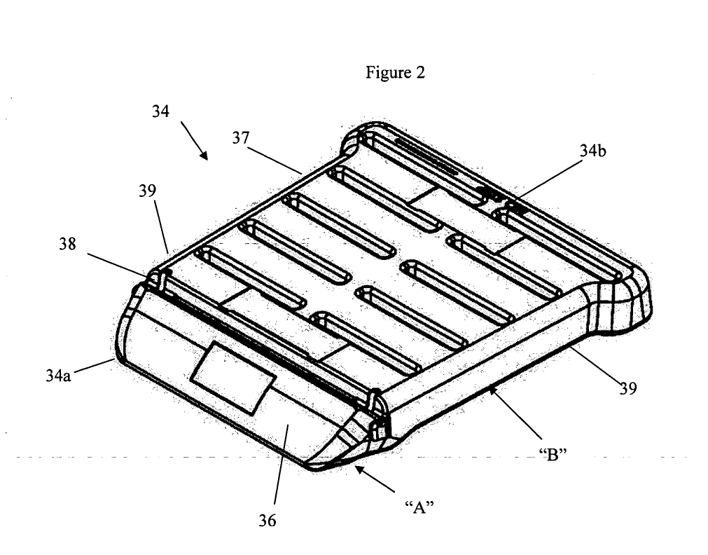

FIG. 2 shows a tray or platform used with the cart frame of FIG. 1. The platform is generally depicted as reference numeral 34 and may be considered a module unit. The module unit may be manufactured from a molded plastic, wire meshing or other appropriate material. The platform includes a sloped end portion 36 which may be shaped as a ramp. As shown in even more detail, the sloped end portion may include a “scalloped” portion, e.g., a curvature, extending from the front portion 34a. The sloped end portion 36 is designed, in one aspect, to lift a rear portion of another cart during the coupling or nesting operations. The sloped end portion 36 leads to a recess or groove 38 extending the width of the platform 34. The groove 38 includes apertures 39 designed to align with the plates 30. In this way, the groove 38 will also align with the slots 32 of the respective plates 30. The groove 38, like that of the slots, is designed to accommodate a cross bar (e.g., spreader bar) of another cart for coupling or mounting of the other cart.

The front portion 34a of the platform has a dimension “A” and the rear portion 34 or other portions of the platform have a dimension “B”, which in one aspect may be greater than dimension “A”. The dimension “A” is a width slightly smaller than that of a spacing between a frame member of another cart (either the same type or different type of cart) to allow for a self aligning feature when coupling or nesting of two carts. In the former scenario, the smaller width will allow the ramp portion 36 to fit between the frame members of another cart and guide the spreader bar of the other cart into the coupling mechanism of the invention. Drainage slots 37 may also be provided on the upper surface of the platform 34.

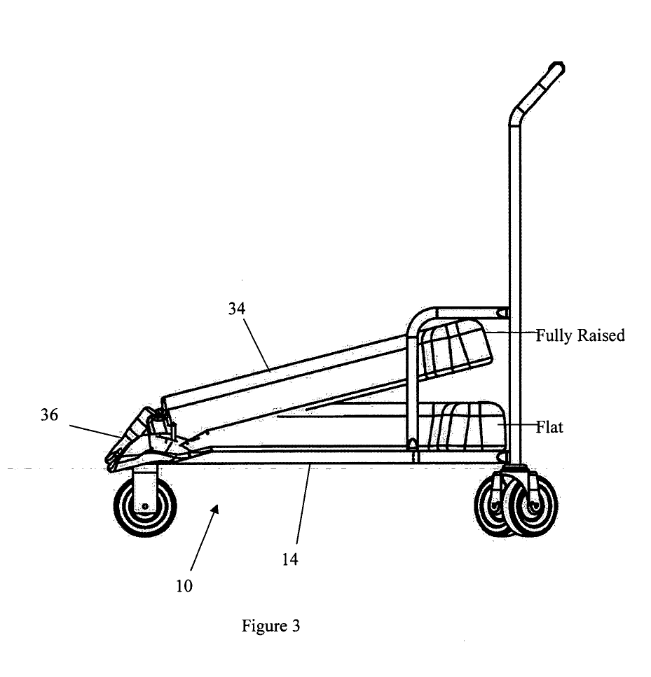

FIG. 3 shows a side view of the platform 34 attached to the cart 10. As seen in the view of FIG. 3, the platform 34 may be pivotally mounted to the frame member 14 of the cart 10 such that it can be raised or lowered into a flat position for storage. Accordingly, the platform 34, as shown, can be in either the fully raised position or the flat position or other intermediate position. By having the platform pivotally mounted, it is possible to nest the same type of carts together, as well as to easily disengage the spreader bar of a cart from the coupling mechanism (e.g., slot 32 and the groove 38) by raising the platform. That is, raising the platform 34 will disengage the spreader bar of the coupled cart from the slot and groove by moving the cross bar forward out of the slot and groove.

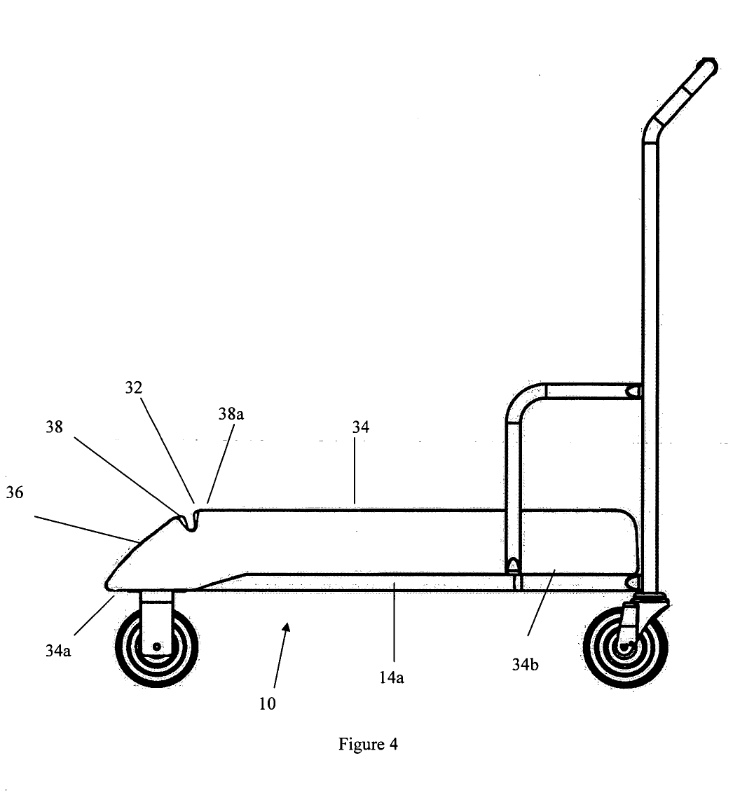

FIG. 4 also shows a side view of the platform 34 and cart 10. This view shows a side profile of the platform, where the front portion 34a extends lower than the rear portion 34b of the platform. This is seen by the relative positions of the front portion 34a and the rear portion 34b with respect to the horizontal frame member 14a. This configuration may serve at least four purposes:
(i) the lower profile of the front portion allows the cart to easily be positioned underneath another cart;
(ii) the lower profile of the front portion allows for easy nesting of the same carts;
(iii) the higher profile of the rear portion also allows for easy nesting of the same carts; and
(iv) the higher profile of the rear portion may allow for the consumer to easily disengage the coupling mechanism from the spreader bar in order to separate the carts.

FIG. 4 also shows that the profile of the groove 38 is not the same as that of the slot 32. In one aspect of the invention, the groove 38 includes a substantially vertical rear wall 38a which is not at a same angle as that of the slot 32. In this manner, a portion of the plate forming the slot 32 will extend distally beyond the rear wall 38a of the groove 38 and thus extend within the groove 38. This will act as a “catch” mechanism to ensure that the spreader bar of a coupled cart will remain within the groove 38 by slightly overhanging such spreader bar. The wall 38a may also be at other angles with respect to a vertical axis.

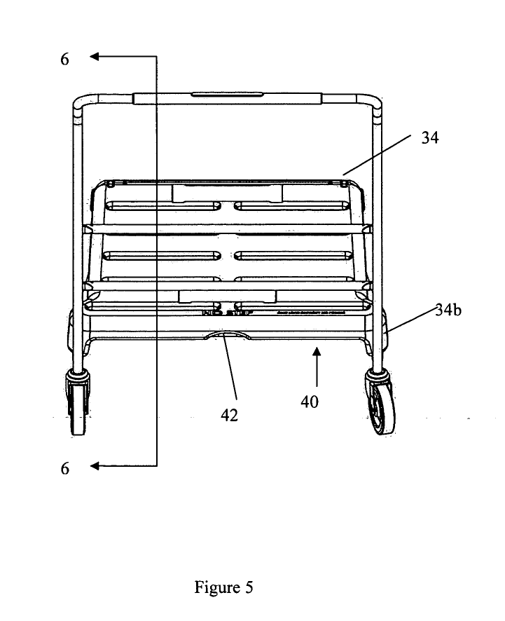

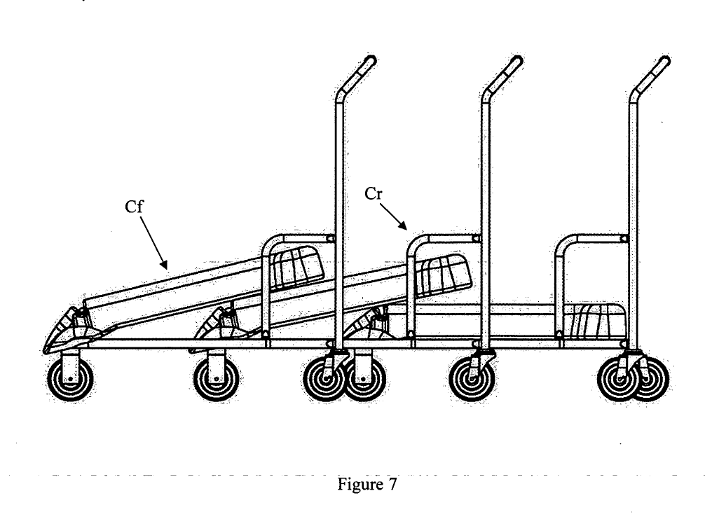

FIG. 5 shows an exploded rear view of the cart of the invention. This rear view shows that the platform 34 has a raised clearance 40 and a notched section 42 at the rear portion 34b. The remaining side portions of the platform rest on the frame member 14 so that the platform can be pivoted between the flat position and the raised position. The raised clearance 40 allows for the nesting of like carts as discussed with reference to FIG. 7. The notch 42, which may be optional, allows the user to pivot the platform upwards, manually, so as to detach a coupled cart, for example.

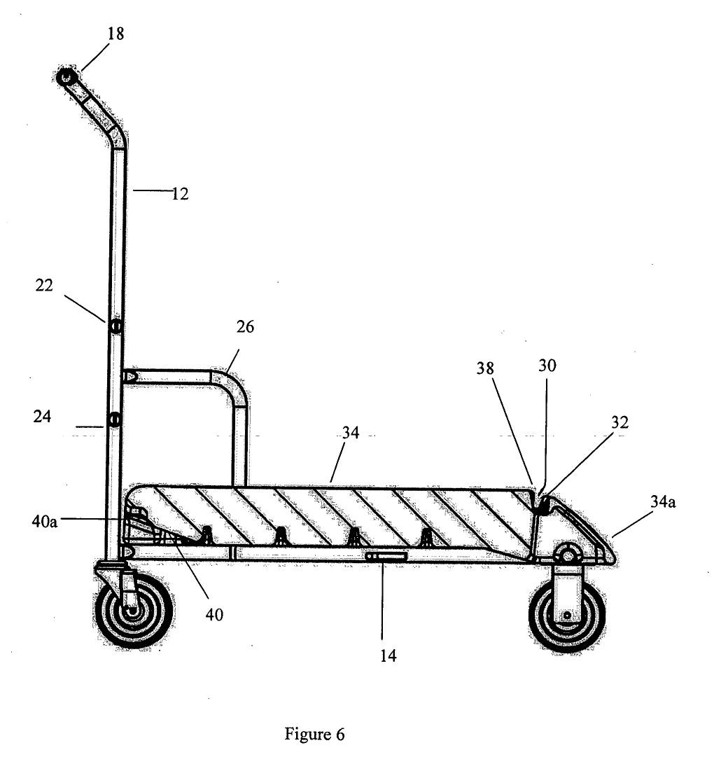

FIG. 6 shows a cutaway view of the cart along line 6-6 of FIG. 5. This view shows the raised clearance 40 and the profile of the platform, itself. The raised clearance 40 may include a rear slope 40a used to accommodate and better facilitate the nesting feature of the carts. The platform is also shown to include the side profile with the front portion 34a extending lower than the rear portion 34b of the platform. This is, again, seen by the relative positions of the front portion 34a and the rear portion 34b with respect to the frame member 14a.

FIG. 7 shows the nesting of carts. By way of example, when the carts are nested the platform of a front cart “C_{F}” will be raised by the platform of a rear cart “C_{R}”, for example. More specifically and referring to both FIGS. 5 and 7, the ramp portion 36 of the rear cart C_{R} will be positioned and aligned within the raised clearance 40 of the front cart C_{F}. As the rear cart C_{R} is moved toward the front cart C_{F}, the platform of front cart C_{F} will begin to raise via the ramp 36. When the carts are fully nested, the platform of the front cart C_{F} may be in a substantially fully raised position. Although not shown in FIG. 7, the cross bar 28 may be positioned to mechanically interfere with the front portion 34a of the platform in order to prevent further movement of the rear cart C_{R}. In other words, the cross bar 28 may act as a stop which is designed and positioned to contact the front portion 34a of the platform to prevent further forward movement of the rear cart C_{R}.

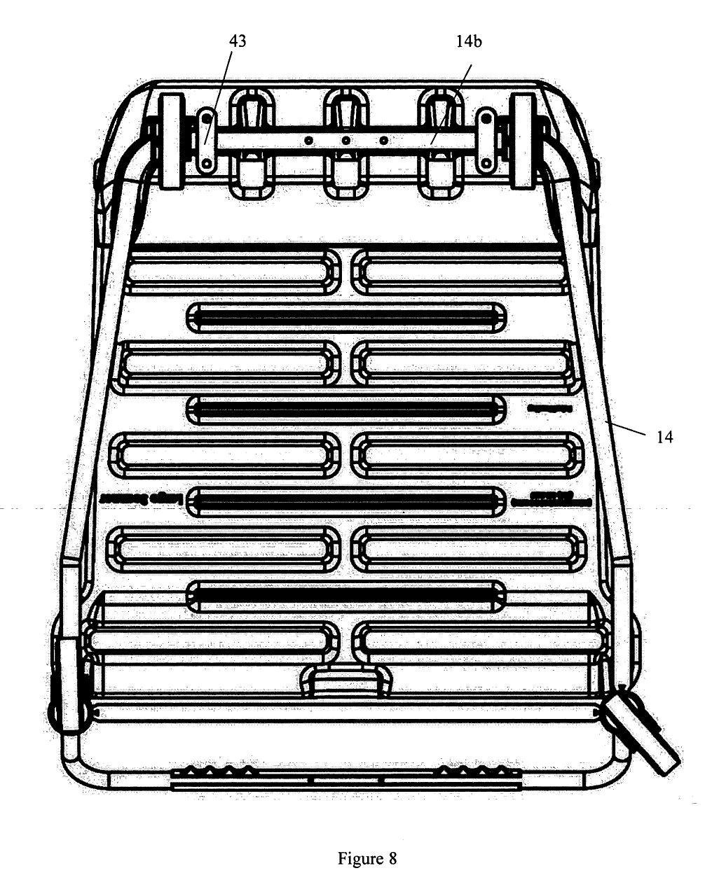

FIG. 8 shows a representative view of an underside of the cart and platform. In this view, the platform is shown to be mounted to the front, transverse frame member 14b of the frame member 14 by a set of brackets or straps 43. In one example, the straps 43 are bolted to the underside of the platform and about the front, transverse frame member 14b of the frame member 14. This mounting mechanism permits the pivoting of the platform 34, as shown in FIG. 3.

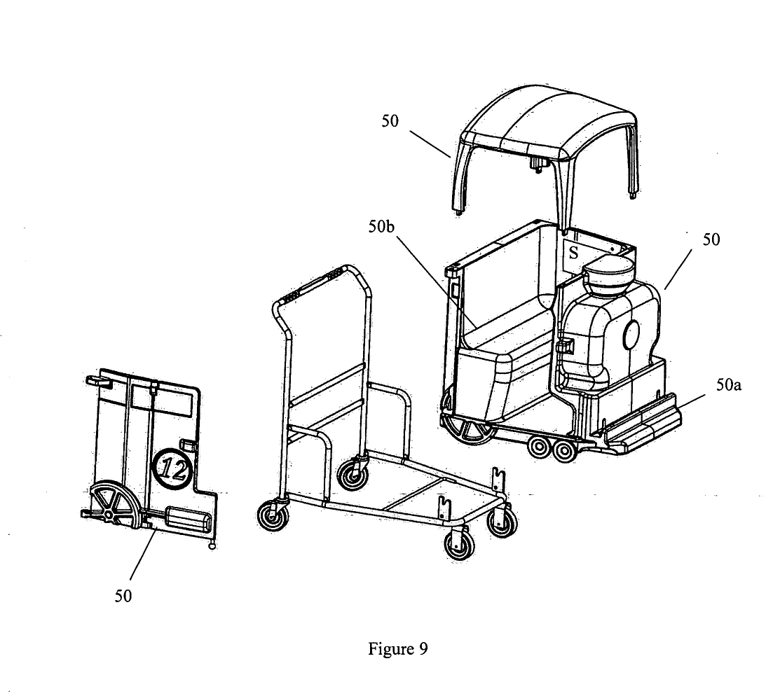

In different aspects of the invention, the cart may be retrofitted with other module-like platforms for the accommodation of a child or children, or equally a storage system for transporting goods. In one embodiment, as shown in FIG. 9, several module pieces may be fitted to the cart, as depicted generally as reference numeral 50. These modules 50 may be plastic or other material; however, in the preferred implementation a molded plastic is used by the invention. In the representation of FIG. 9, the modules 50 form a train engine. In this embodiment, the front portion 50a will provide some or all of the same features of the front portion of the previously described embodiment. For example, the front portion may be sloped and include a groove for aligning with the slots 32 and acting as a coupling mechanism. A seat 50b may also be provided to accommodate one or more children.

As shown, the module may also include a screen S (entertainment system) for the users. This may include WiFi access to the Internet or any wireless communication means, gaming and/or video (such as DVD). The screen may be used for promotional or advertisements, as well, any of which may be transmitted from the retail environment or a remote location. The screen and related components such as receivers, transmitters, logic controllers and the like are all well known in the art and can be adapted for the uses contemplated herein.

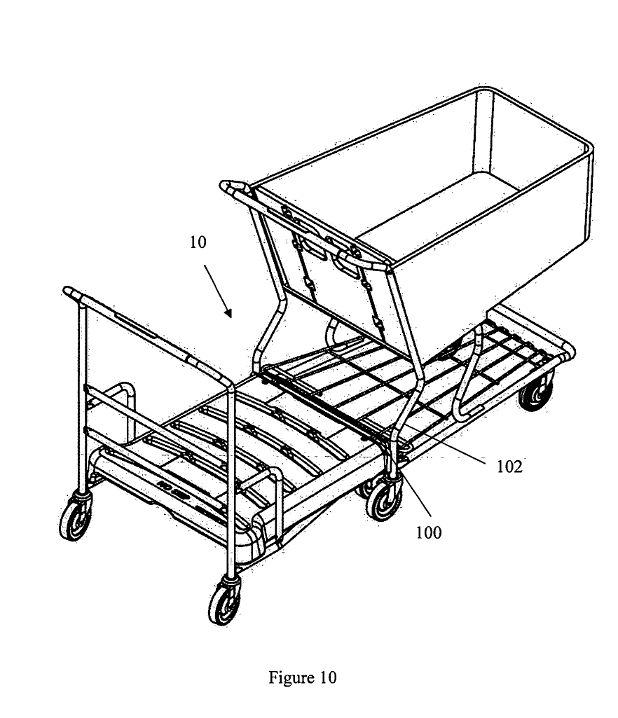

FIG. 10 shows a first type of cart coupled to a second type of cart. In one embodiment, the first type of cart may be a general purpose merchandise cart and the second type of cart may be a conventional shopping cart. In this illustration, the shopping cart includes a spreader bar 100 or other bar (whether original or retrofitted) extending between frame members 102. The spreader bar 100 is of such a configuration, e.g., height and length, to fit or couple within the groove 38 and slot 32. It should be understood by those of ordinary skill in the art that the plate and slot may be eliminated such that the groove provides the coupling mechanism of the two carts. It should be also understood by those of ordinary skill in the art that the invention is not limited to a general purpose cart and a shopping cart, and that other carts can easily be used within the scope of the invention. For example, other types of carts may have or be retrofitted with a cross bar or spreader bar to fit within the coupling mechanism of the invention. The coupling mechanism of the invention, may also couple with an already existing frame member, basket or other feature of another cart.

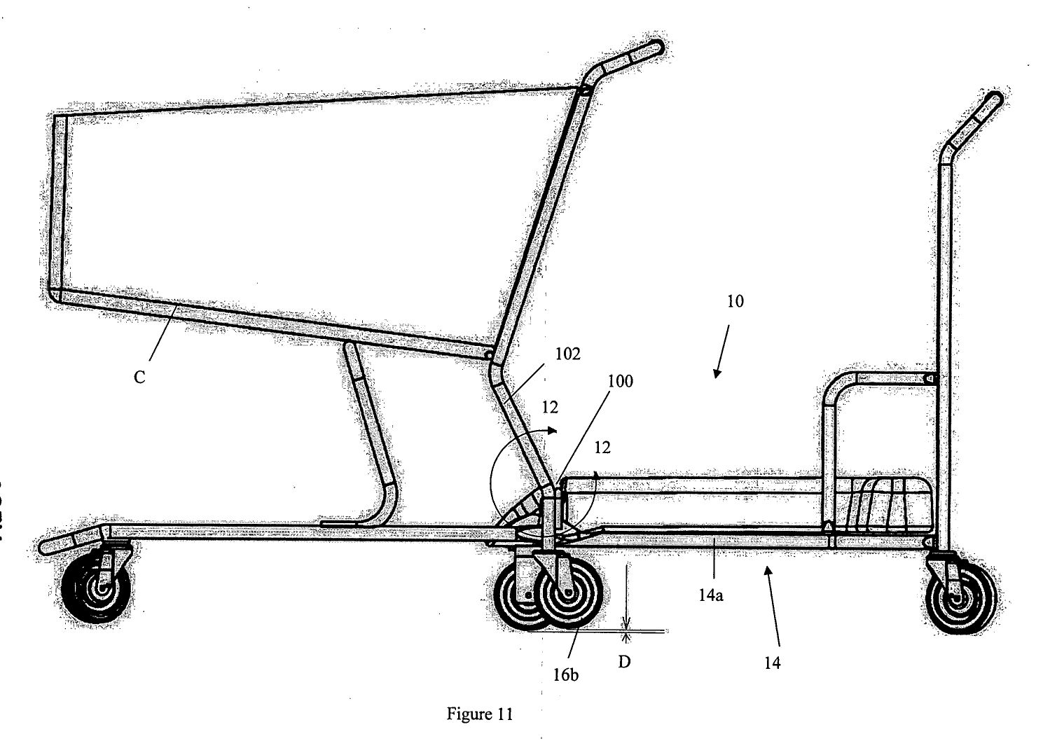

FIG. 11 shows a side view of the coupled carts of FIG. 10. As seen, the cargo or storage capacity of the coupled carts is increased as compared to either of the carts, alone. This provides the flexibility and versatility of expanding the cargo carrying capacity of a single cart for the consumer. In the coupled configuration, the rear wheels 16 of the shopping cart “C”, for example, are also slightly raised from a support surface by a distance “D” due to the relative height of the spreader bar 100 and coupling mechanism of the invention. This allows for easier maneuverability of the combined cart. That is, in this configuration, the combined carts are maneuverable six wheeled carts with swivel casters at each end. In one embodiment, the entire assembly will be able to pivot about the center rigid wheels (e.g., front wheels 16b).

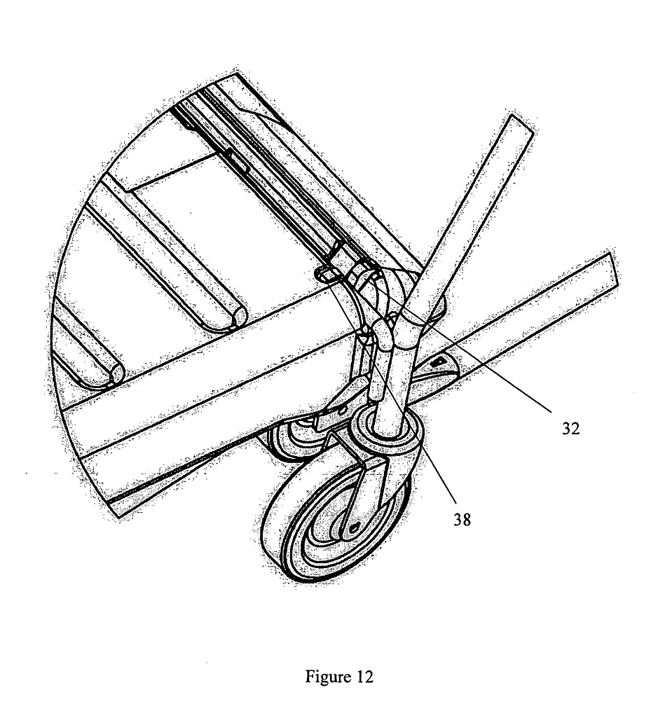

FIG. 12 shows an exploded view of the coupling mechanism in accordance with one aspect of the invention, along line 12-12 of FIG. 11. The spreader bar 100 is shown to be coupled to the slot 32 and positioned within the groove 38. In this representation, the plate 30 includes two portions, encompassing the slot 32, which do not match the profile of the groove 38. This configuration may act to securely couple the two carts, ensuring that the carts do not disengage during normal use.

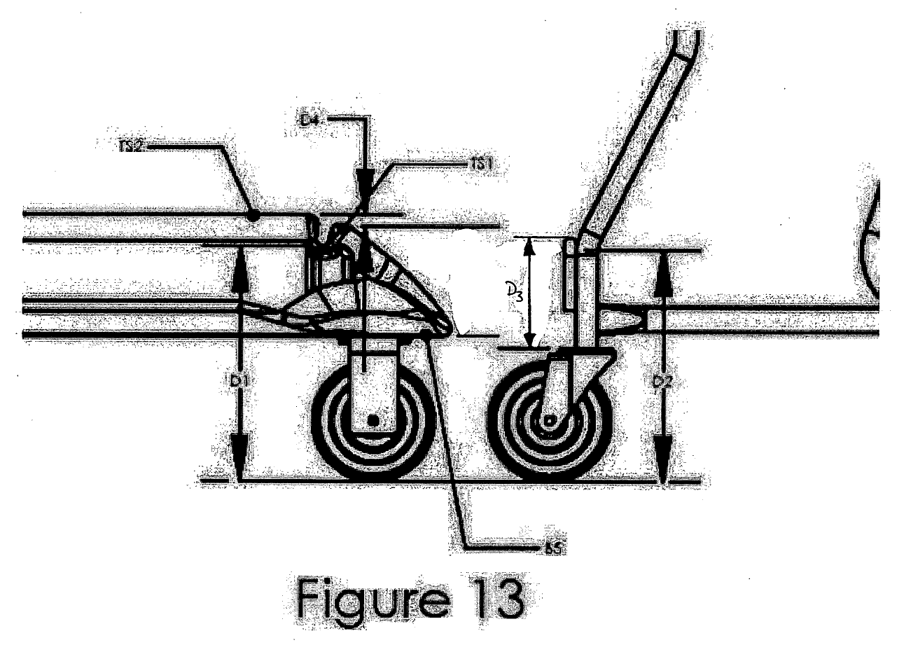

FIG. 13 shows an exploded view of a front portion of the cart 10 and a rear portion of the shopping cart “S”. As shown in this illustrative example, the height from the supporting surface to a lower portion of the coupling mechanism is “D₁”; whereas, the height from the supporting surface to the spreader bar is “D₂”. In one embodiment, D₁>D₂ thus resulting in the rear wheels of the shopping cart “S” lifting when the carts are coupled together. It should be recognized that the spreader bar may be at a same height as the coupling mechanism. Additionally, the representation of the spreader bar may equally be any other bar or frame member, as well as the shopping basket itself, for coupling to the coupling mechanism. Also, in one embodiment of the invention:
(i) a height of the front portion of the platform is lower than that of the spreader bar 100 by a predetermined distance D₃ such as, for example, approximately ⅛ of an inch;
(ii) a distance between the spreader bar and the rear wheel mount “R” of the shopping cart “S” is greater than a distance between the bottom surface of the platform B_{S} and a top surface of the platform T_{S1}, near the coupling mechanism; and
(iii) the top surface T_{S2} is higher than the top surface T_{S1}.

In this configuration, the front portion of the platform can be initially placed underneath the spreader bar 100 to lift the rear portion of the shopping cart from the supporting surface as the spreader bar 100 slides on the ramp portion 36 of the platform or other module. Additionally, the distance described in (ii) may prevent the shopping cart from accidentally disengaging from the coupling mechanism due to bumps and other jarring events. Lastly, the distance described in (iii) may prevent the spreader bar 100 from disengaging from the coupling mechanism and “creeping” onto the top surface of the platform or other module.

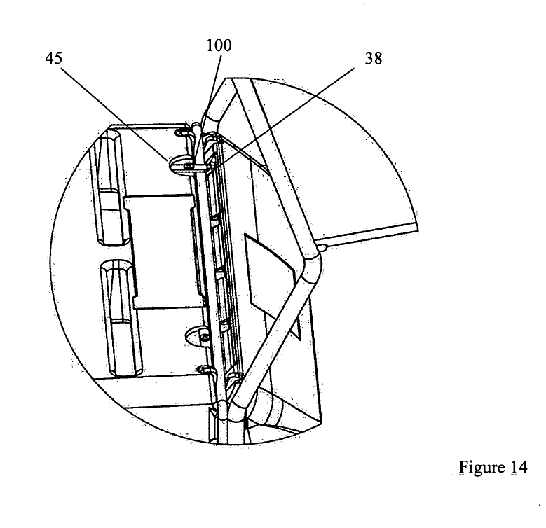

FIGS. 14-16 show supplemental or alternative coupling mechanisms. In FIG. 14, a rotating metal or rigid strap 45 may be provided to span the groove 38. In use, the strap 45 may be rotated away from the groove 38 so that the spreader bar 100 can seat therein. Once the spreader bar 100 is properly seated, the strap 45 may be rotated over the groove 38 to ensure that the cross bar remains within the groove 38. The strap may be rotated again to allow the spreader bar to disengage from the coupling mechanism to then detach or separate the carts.

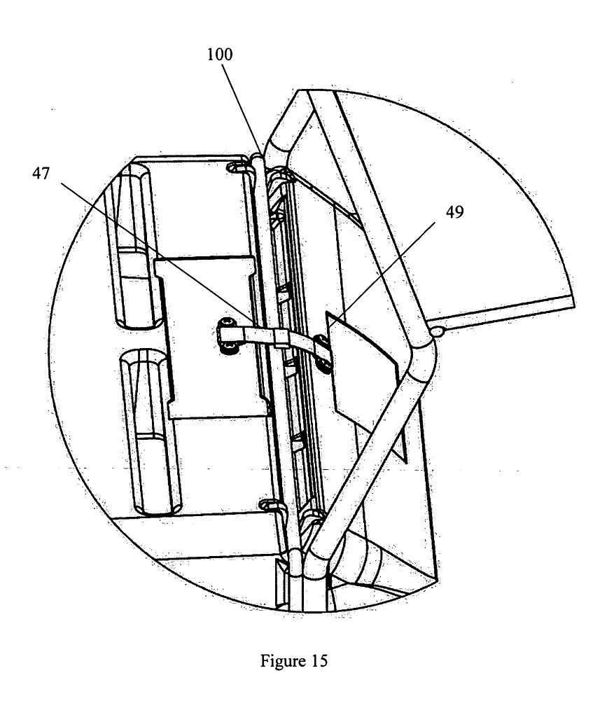

FIG. 15 shows metal or fabric straps with buckles (generally represented by reference numeral 47). In use, the strap 47 may be unbuckled so that the cross bar can seat within the groove 38. Once the spreader bar 100 o(or other feature or frame member as discussed) is properly seated, the strap can be buckled of fastened over the groove 38 to ensure that the cross bar remains within the groove 38. The strap 47 may be unbuckled or unfastened to allow the spreader bar 100 to disengage from the coupling mechanism. The strap 47 may be held in place by metal strips, screws or other fastening mechanisms shown as reference numeral 49.

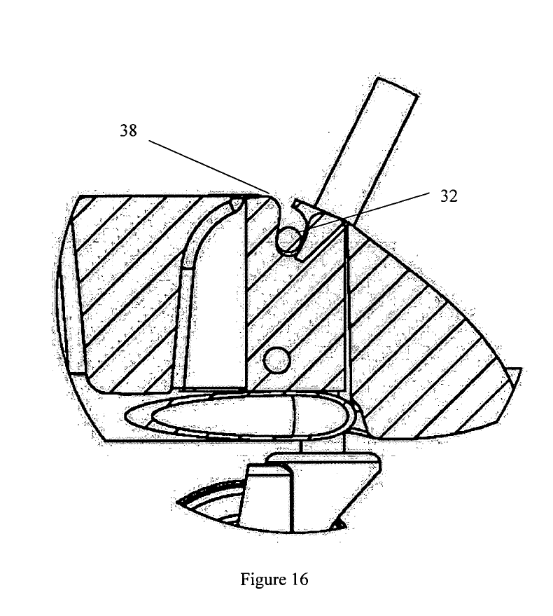

FIG. 16 shows an alternative coupling mechanism. This alternative coupling member includes a slot and plate, like that shown in FIG. 1, for example. However, the groove includes a profile that is different from that shown and described with reference to FIG. 2, for example. In this embodiment, the groove has a cross section which is positioned in an opposing manner to the direction of the slot 32. By way of one example, the groove includes a first profile offset from a first side of a vertical axis and the slot includes a second profile offset from a second side of the vertical axis. In this configuration, a portion of the plate forming the slot extends within first profile. Also, as the platform 38 rotates downward, the slot 32 and the groove 38 will capture the spreader bar to firm hold it within the coupling mechanism.

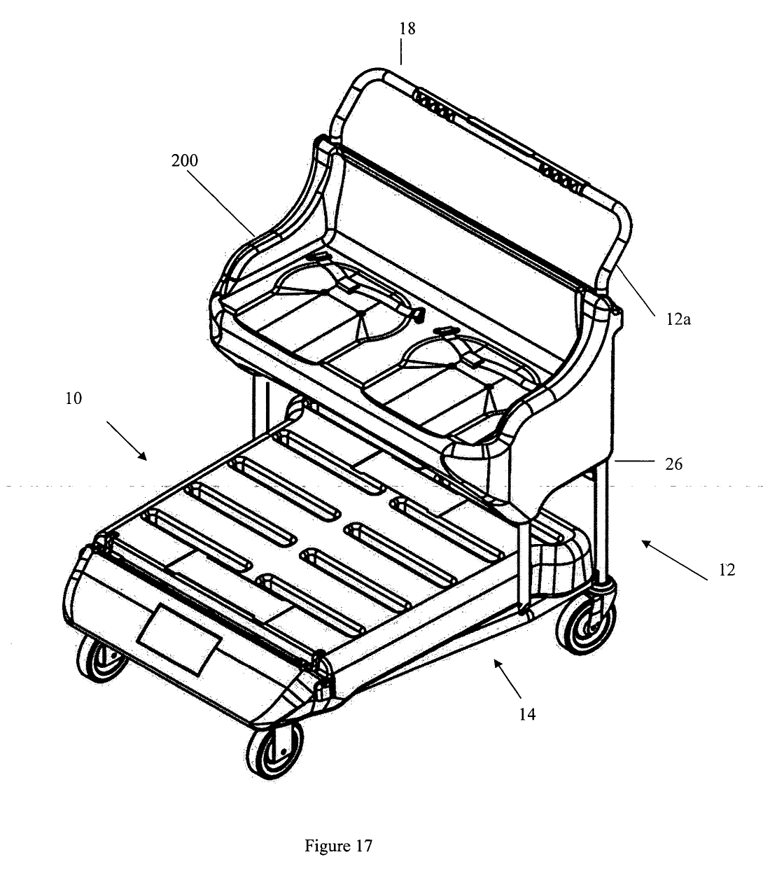

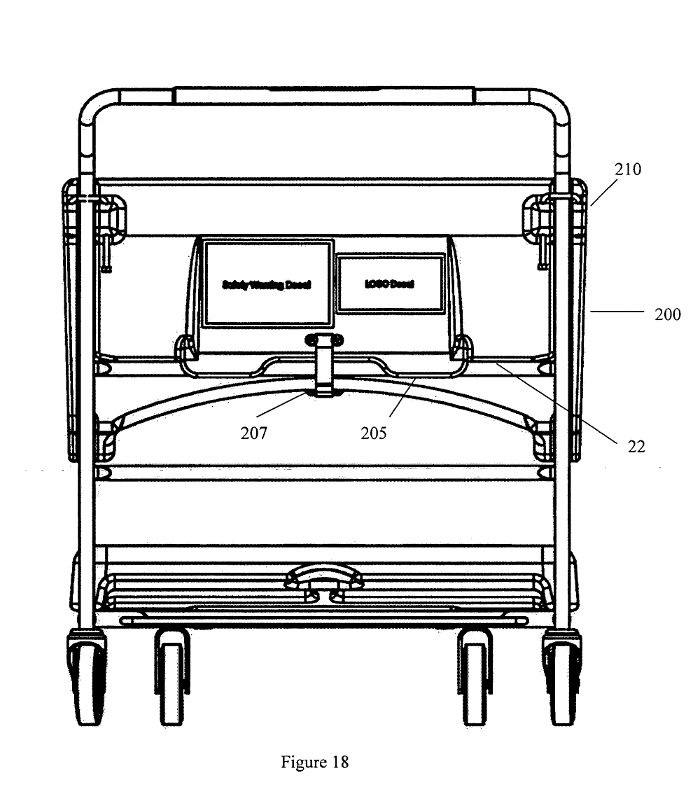

FIG. 17 shows an embodiment of the invention with a removable seat 200. The removable seat 200 detachably rests on the support bars 26 and is removable from the upright members 12a. As shown in FIG. 18, the seat 200 also rests on the cross bar 22 via a shaped protruding portion 205 which has an engaging surface that may conform to the shape of the cross bar 22. A strap 207 may be used to fasten the removable seat 200 to the cross bar 22. A set of locking mechanisms 210 is coupled to the upright frame members 12a.

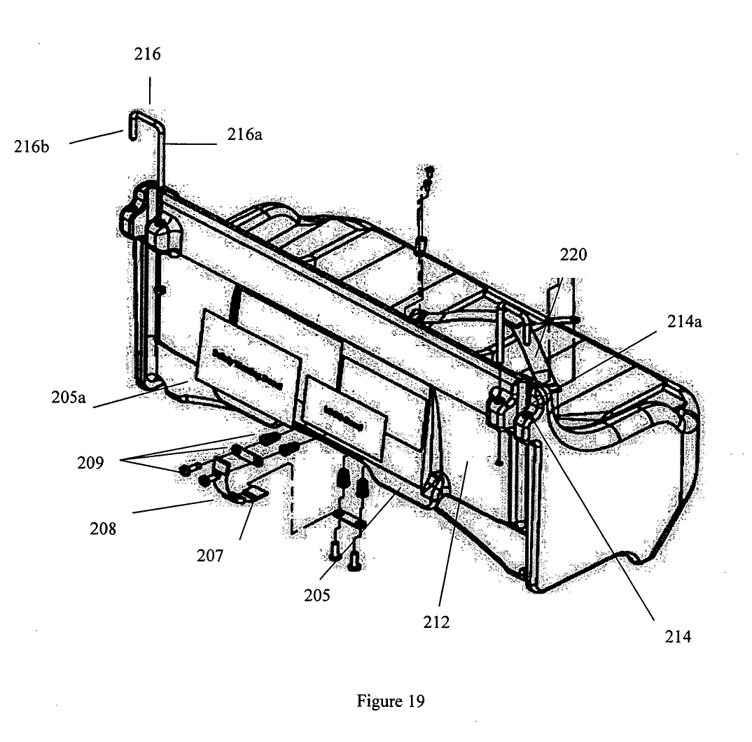

FIG. 19 shows an exploded view of the removable seat 200. The removable seat 200 includes a protruding portion or flange 205 having a bottom, engaging surface 205a for resting on the cross bar 22. A strap 207 having a buckle 208, for example, extends from the flange portion 205 to an underside of the removable seat, spanning the engaging surface 205a. The strap 207 is fixed to the removable seat by hardware 209 such as screws, sleeves and washers. In operation, the buckle 208 allows the strap 207 to be fastened to the cross bar 22 thus additionally securing the removable seat 200 to the cart 10.

A set of ribs or protruding portions 214 is positioned on a first and second side of the rear surface 212 of the removable seat. The ribs of each set of ribs is positioned and configured to form a recess to allow the upright member 12a to seat therein (FIG. 18). A bore 214a is provided in each of the ribs to accommodate a pin 216. The pin 216 is substantially “C” shaped such that two legs of the pin 216 can be inserted within each bore of the set of ribs. The pin can equally represent a rotating strap similar to that shown in FIG. 14, a strap with a fastening device (e.g., buckle) as shown in 15, or a latch mechanism known to those of skill in the art.

In one preferred embodiment, the pin includes a leg 216a having a threaded portion passing completely through the bore so that it can be coupled with a nut or other fastening mechanism. This will ensure that the pin remains captured within the bore when the seat is removed from the cart. In this embodiment, the length of the leg 216a should be longer than the length of the leg 216b in order to allow the pin to be lifted and rotated thus disengaging the shorter leg 216b from the bore. In one embodiment, the bores 214a are substantially parallel with the upright frame members 12a. A belt or belts 220 for strapping a person in the removable seat 200 is also provided.

### In Operation

In one embodiment of operation, a rear cart is positioned behind a front cart. The rear cart is then moved forward at which time the ramp portion of the platform will be substantially aligned with the frame member of the front cart. As the rear cart is moved forward, the ramp portion will begin to engage the cross bar or spreader bar of the front cart. This will then begin to lift the rear portion of the front cart slightly from the supporting surface resulting in the wheels lifting or disengaging from such supporting surface. As the rear cart is moved forward, the spreader bar of the front cart will engage the coupling mechanism. At this operational stage, the two carts will be firmly and securely coupled to one another. To provide supplemental coupling, a strap or other similar mechanism may be placed over the spreader bar and spanning the groove, thus ensuring that the two carts will not accidentally detach from each other. To detach the carts from one another, the user can simply rotate the platform upwards by raising the rear portion which, in turn, will disengage the spreader bar from the coupling mechanism. The user may also lift the front cart. In this manner, no special tools are required and the consumer can easily attach (and separate) carts within the retail environment to provide added cargo capacity of the combined assembly.

To nest the same type of carts, the rear cart is positioned and aligned with the front cart. The ramp portion is placed underneath the raised clearance of the front cart which, as the rear cart is moved forward, will begin to lift the platform. When the carts are fully nested, the platform of the front cart may be in a substantially fully raised position. The lower cross bar spanning between the horizontal frame members of the front cart will prevent or stop movement of the rear cart at a predetermined distance such as, for example, approximately ½ length of the cart.

To install the removable seat, the removable seat is placed on the support members. The engaging surface is then positioned on the upper cross bar and the upright frame members are placed within the recesses or spaces formed by each set of ribs. During this operational stage, the pin is not engaged with both of the bores of the ribs. When the removable seat is placed on the frame of the cart, the buckle may then be snapped and the pin rotated such that the shorter end of the pin engages within one of the bores of the ribs. This will securely fasten the removable seat to the cart frame. To remove the removable seat, the pins are lifted and rotated, and the buckle is unsnapped. The removable seat is then removed from the frame.

While the invention has been described in terms of embodiments, those skilled in the art will recognize that the invention can be practiced with modification within the spirit and scope of the appended claims.

1. A cart, comprising:
a frame member;
a module unit pivotally mounted to the frame member; and
a coupling mechanism associated with the module unit which is adapted to be removably engagable with a frame member or basket of another cart.

2. The cart of claim 1, wherein the coupling mechanism includes a groove positioned along a widthwise direction of the module unit.

3. The cart of claim 1, wherein the module unit is a platform having a ramped front portion.

4. The cart of claim 3, wherein the ramped front portion is scalloped and is a guide to the coupling mechanism.

5. The cart of claim 1, wherein the coupling mechanism includes at least one plate having an angled slot.

6. The cart of claim 5, wherein the coupling mechanism further includes a groove formed in the module unit and which communicates with the at least one plate having the angled slot.

7. The cart of claim 6, wherein a portion of the angled slot protrudes beyond a wall of the groove.

8. The cart of claim 6, wherein the groove has a different cross sectional profile than that of the angled slot.

9. The cart of claim 6, wherein the groove includes at least one aperture such that the at least one plate is positionable therethrough and is combined within the groove to form the coupling mechanism.

10. The cart of claim 6, further comprising a strap spanning the groove.

11. The cart of claim 10, wherein the strap is a rigid strap which is rotatable or is a strap having a buckle or fastener.

12. The cart of claim 1, further comprising a detachable strap spanning the coupling mechanism.

13. The cart of claim 1, wherein the coupling mechanism includes:
a groove formed in the module unit having a first profile; and
a slot formed in a plate extending from the frame member and combined with the groove, the slot having a second profile different from the first profile.

14. The cart of claim 13, wherein:
the first profile includes a first angle offset from a first side of a vertical axis;
the second profile includes a second angle offset from a second side of the vertical axis; and
a portion of the plate forming the slot extends within first profile.

15. The cart of claim 13, wherein the module unit includes:
a first portion having a dimension “A”; and
a second portion having a dimension “B”, wherein “B”>“A”

16. The cart of claim 15, wherein:
the first portion is a front portion and the second portion is remaining portions; or the first portion is a height profile of the rear portion and the second portion is a height profile of the front portion.

17. The cart of claim 1, wherein the module unit includes a raised clearance portion at a rear portion thereof, the raised portion being higher than a ramped nose portion at another end of the module unit.

18. The cart of claim 17, wherein the raised clearance portion includes a sloped portion.

19. The cart of claim 17, wherein the module unit includes a notch at a rear portion thereof.

20. The cart of claim 1, further comprising a set of rear wheels and a set of front wheels mounted to the frame member, the set of rear wheels being pivotally mounted about a vertical axis and the set of front wheels being rigidly mounted.

21. The cart of claim 1, wherein the frame member includes:
a first substantially U-shaped frame member;
a second substantially U-shaped frame member positioned substantially orthogonal to the first substantially U-shaped frame member; and
a stop bar extending between opposing legs of the second substantially U-shaped frame, the stop bar adapted to contact a front portion of a nested cart to limit travel thereof.

22. The cart of claim 21, further comprising a removable seat mounted to the first frame member via a protruding portion and a pinned mechanism.

23. The cart of claim 22, wherein the protruding portion includes an engaging surface contacting a cross member of the first substantially U-shaped frame member.

24. The cart of claim 23, wherein the pinned mechanism includes a recessed portion between ribbed portions for engaging upright members of the first substantially U-shaped frame member and a pin moveable into and out of engagement with at least one bore of the ribbed portions.

25. The cart of claim 1, wherein the module unit in the raised position ejects the frame member or basket of the another cart from the coupling mechanism.

26. The cart of claim 1, wherein the module unit in a flat position will substantially lock the frame member or basket of the another cart into the coupling mechanism.

27. A nestable cart, comprising:
a frame member;
a platform pivotally mounted to the frame member between a flat position and a raised position, the platform having a front portion lower than a rear portion with respect to a supporting surface; and
a coupling mechanism associated with the platform, the coupling mechanism including at least a groove extending widthwise within a front portion of the platform.

28. The nestable cart of claim 27, further comprising a cross bar member extending between components of the frame member, the cross bar member being at a height higher than that of the front portion of the platform and lower than remaining portions thereof.

29. The nestable cart of claim 27, wherein the platform includes:
a first width at the front portion and a second width at the rear portion, wherein the first width is less than the second width, and
a raised clearance at the rear portion which is higher than a ramped nose portion of the front portion.

30. The nestable cart of claim 27, wherein the coupling mechanism couples to a feature of another cart.

31. The nestable cart of claim 30, wherein the coupling mechanism further includes a plate extending from the frame member and having a slot which aligns within the groove.

32. The nestable cart of claim 31, wherein:
the groove has a first profile, the first profile includes a first angle offset from a first side of a vertical axis;
the slot has a second profile different from the first profile, the second profile includes a second angle offset from a second side of the vertical axis; and
a portion of the plate forming the slot extends within first profile.

33. An array of nestable carts, comprising:
a first cart, comprising:
a frame ember; and
a module unit pivotally mounted to the frame member between a flat position and a raised position, the module unit having a front portion lower than a rear portion with respect to a supporting surface; and
a coupling mechanism associated with the module unit including at least a groove extending within the module unit; and
a second cart, comprising:
a frame member; and
a module unit mounted to the frame member, the module unit having a front portion lower than a rear portion of the module unit of the first cart, wherein
a portion of the frame member and module unit of the second cart is positioneable underneath the module unit and between frame components of the frame member of the first cart, and
a rear portion of the module unit of the first cart is positionable in the raised position.

34. The array of nestable carts of claim 33, further comprising a cross member of the frame member of the first cart contacting a front portion of the module unit of the second cart to limit travel of the second cart.

35. An assembly, comprising:
a first cart, comprising:
a frame member; and
a platform pivotally mounted to the frame member between a flat position and a raised position, the platform having a front portion lower than a rear portion with respect to a supporting surface; and
a coupling mechanism combinable with the platform; and
a second cart, comprising:
a frame member having a bar or basket at a height lower than or at a height of a lower portion of the coupling mechanism; and
wheels rotatably mounted to the frame member;
wherein the coupling mechanism engages the bar or the basket of the frame member of the second cart when the platform and a portion of the frame member of the first cart nest within frame components of the frame member of the second cart.

36. The assembly of claim 35, wherein the platform is in a flat position when the coupling mechanism engages the cross bar of the frame member of the second cart.

37. The assembly of claim 35, wherein:
a height from a supporting surface to a lower portion of the coupling mechanism a height from the supporting surface to the cross bar is “D₂” and D₁>D₂ thus resulting in rear wheels of second cart lifting when the first and second cart are coupled together.

38. The assembly of claim 35, wherein
(i) a height of the front portion of the platform is lower than that of the cross bar by a distance D₃;
(ii) a distance between the cross bar and a rear wheel mount of the second cart is greater than a distance between a bottom surface of the platform and a top surface of the platform proximate the coupling mechanism; and
(iii) the top surface at one side of the coupling mechanism is higher than the top surface at another side of the coupling mechanism.

39. The assembly of claim 38, wherein
a front portion of the platform is at a height such that the front portion is initially placed underneath the cross bar to lift the rear portion of the second cart from the supporting surface as the cross bar slides on a ramp portion of the front portion of the module unit; and
the distance (ii) prevents the second cart from disengaging from the coupling mechanism; and
the distance (iii) prevents the cross bar from disengaging from the coupling mechanism and creeping onto the top surface of the platform on the one side of the coupling mechanism.

40. The assembly of claim 35, further comprising a rotating strap spanning the coupling mechanism when the cross bar is engaged within the coupling mechanism.

41. The assembly of claim 35, wherein the frame member of the first cart includes a stop bar at a height lower than a portion of a platform of the second cart to prevent excess travel of the second cart.

42. A removable seat, comprising:
a seat portion;
a rear portion proximate to the seat portion having an engaging surface and a recess portion positioned between a locking mechanism, the locking mechanism including a lock movable between a first position and a second position.

43. The removable seat of claim 42, further comprising a strap detachably spanning the engaging surface.

44. The removable seat of claim 42, wherein:
the locking mechanism is a pinned mechanisms and the lock is a pin,
the pin includes a first portion longer than a second portion and a spanning portion connecting the first portion to the second portion, the spanning portion being of a length to span the recess portion;
the pinned mechanism includes a first protruding portion and a second protruding portion, forming the recess, the first protruding portion and the second protruding portion having a bore therein, and
the first portion positioned within the bore of the first protruding portion and the second portion being removably positioned within the bore of the second protruding portion.

45. The removable seat of claim 44, further comprising a strap spanning the engaging surface and having a detachable mechanism.

46. The removable seat of claim 42, wherein the locking mechanism is a rotating strap or a strap having a fastening mechanism.

47. A cart, comprising:
a frame member;
a module unit attached to the frame member; and
a coupling mechanism communicating with the module unit which is removably engagable with a frame member or basket of another cart.

48. The cart of claim 47, wherein the coupling mechanism includes a groove extending substantially along a width of the module unit.

49. The cart of claim 47, wherein the coupling mechanism includes a groove extending substantially along a width of the module unit and at least one plate having a slot which aligns within the groove.

50. The cart of claim 49, wherein:
the groove has a first profile, the first profile includes a first angle offset from a first side of a vertical axis;
the slot has a second profile different from the first profile, the second profile includes a second angle offset from a second side of the vertical axis; and
a portion of the plate forming the slot extends within first profile.

51. The cart of claim 47, wherein the module unit is pivotally mounted to the frame member and is moveable between a lowered position and a raised, nestable position.

52. The cart of claim 47, wherein the module is a themed module.

53. The cart of claim 47, wherein the module further includes a viewable screen.
